(19) United States
(12) Patent Application Publication
(10) Pub. No.: US 2024/0297509 A1
(43) Pub. Date: Sep. 5, 2024

(54) DEVICE AND METHOD FOR CONTACT-CONNECTING AN ELECTRIC VEHICLE TO A CHARGING STATION, AND CHARGING STATION

(71) Applicant: Robert Bosch GmbH, Stuttgart (DE)

(72) Inventors: Dirk Wolf, Renningen (DE); Oliver Blum, Renningen (DE)

(21) Appl. No.: 18/570,753

(22) PCT Filed: Jun. 10, 2022
(86) PCT No.: PCT/EP2022/065802

§ 371 Date: Dec. 15, 2023

(30) Foreign Application Priority Data
Jun. 17, 2021 (DE) 10 2021 206 188.5

(51) Int. Cl. H02J 7/00; B60L 53/16; B60L 53/66

(52) U.S. Cl. CPC H02J 7/0029; B60L 53/16; B60L 53/66

(57) ABSTRACT

The invention provides a device and a method for contact-connecting an electric vehicle to a charging station and to a corresponding charging station. The electric vehicle can be contact-connected to the charging station by automatically lowering contact elements of the electric vehicle onto corresponding contact pads of the charging station. There is provision for additional measurement contacts in order to check reliable contact-connection of the electric vehicle to the charging station. These measurement contacts can be used to check reliable contact-connection of the connections of the electric vehicle to the contact pads of the charging station before the charging process is approved.

### BACKGROUND

The present invention relates to a device and a method for contact-connecting an electric vehicle to a charging station. The present invention also relates to a charging station for charging an electric vehicle.

Fully or at least partially electrically powered vehicles have an electrical energy storage system that provides the electrical energy to drive the vehicle. This energy storage system is usually referred to as a traction battery. In addition to inductive charging systems, in which the electrical energy is transferred from the charging station to a receiver coil in the electric vehicle by means of an alternating magnetic field, so-called conductive charging systems currently exist. Here, the charging device of the electric vehicle is connected to an external charging station by means of a cable connection. Once connected, the charging station provides electrical energy to charge the electric vehicle's traction battery.

The publication DE 10 2014 226 357 A1 describes a charging station and a method for automatically charging an electrical energy storage device in a vehicle. A charging station with a so-called charging robot is proposed, which can establish a galvanic connection between the charging station and a charging socket of an electric vehicle.

### SUMMARY

The present invention provides a device and a method for contact-connecting an electric vehicle as well as a charging station. Further advantageous embodiments are the subject matter of the dependent claims.

Accordingly, the following is provided:
A device for contact-connecting an electric vehicle to a charging station, comprising a first group of contact elements, a second group of contact elements and a positioning device. The first group of contact elements comprises a first power connection and a first measurement connection. The second group of contact elements comprises a second power connection, a protective conductor connection and a second measurement connection. The positioning device is designed to contact-connect the contact elements of the first group of contact elements to a first contact pad of a charging point. Furthermore, the positioning device is designed to contact-connect the contact elements of the second group of contact elements to a second contact pad of the charging point.

The following is furthermore provided:
A charging station for charging an electric vehicle with a first contact pad and a second contact pad. The first contact pad is designed to be electrically connected to a first power connection of a device for contact-connecting an electric vehicle to the charging station. The second contact pad is designed to be electrically connected to a second power connection of the device for contact-connecting an electric vehicle to the charging station. The second contact pad is arranged concentrically around the first contact pad. In particular, an electrically insulating ring is arranged between the first contact pad and the second contact pad.

Finally, the following is provided:
A method for contact-connecting an electric vehicle to a charging station. The method comprises a step of contact-connecting a first group of contact elements to a first contact pad of the charging station. The first group of contact elements comprises a first power connection and a first measurement connection. The method further comprises a step of contact-connecting a second group of contact elements to a second contact pad of the charging station. The second group of contact elements comprises a second power connection, a protective conductor connection and a second measurement connection. The method further comprises steps for checking a first contact resistance between the first power connection and the first measurement connection, a second contact resistance between the second power connection and the second measurement connection and a third contact resistance between the protective conductor connection and the second measurement connection. Finally, the method comprises a step for enabling a charging process if the checked contact resistances fall below a predetermined limit value.

The present invention is based on the realization that an electrical connection generally has to be established in order to connect an electric vehicle to a charging station. To establish this electrical connection, a driver normally has to leave the vehicle and establish this connection manually.

It is therefore an idea of the present invention to take this realization into account and to create a safe, reliable and convenient way of automatically contact-connecting an electric vehicle to a charging station. For this purpose, contact devices are provided on an electric vehicle which makes it possible for the charging device to be securely contact-connected to an external charging station in a simple and reliable manner. In particular, the proposed contact device enables automatic contact-connecting of the electric vehicle to an external charging station. Contact-connecting of the electric vehicle to the charging station and the subsequent charging process can be carried out without manual intervention by a user.

In order to ensure the reliability and safety of the contact-connection, additional measurement contact elements are provided in addition to the power-conducting contact elements. These additional measurement contact elements can be used to check that the connections on the vehicle side make reliable contact-connection to the electrical connections of the charging station. In this way, it is possible to check whether a safe electrical connection has been established when the electric vehicle is automatically contact-connected to the charging station before the charging process starts. Furthermore, the additional measurement contacts also enable continuous or periodic checking of the electrical contact conditions during the charging process. This allows a sufficiently safe electrical contact-connection between the electric vehicle and the charging station to be checked and guaranteed during the entire charging process. The contact elements of the device for contact-connecting the electric vehicle to a charging station can be provided on an underside of the electric vehicle, for example. In this case, for example, the charging station on the floor can provide corresponding contact points. To charge the electric vehicle, the contact elements of the device for contact-connecting the electric vehicle to the charging station can be lowered onto the contact pads of the charging station. For example, spring elements or similar can be provided on each of the contact elements. In this way, a sufficiently high contact pressure of the contact elements on the contact pads of the charging station can be ensured after contact-connecting the charging station. Furthermore, the measurement connections may be slightly offset from the power connections and the protective conductor connection. This means that when the contacts are moved in the direction of the charging station connections, the power connections and the protective conductor connection make contact with the charging station connections first. Only then are the measurement connections connected to the corresponding connections on the charging station. As will be explained in more detail below, the contact elements can also be shielded from an external area by means of a suitable protective device.

To check a reliable electrical connection between the contact elements and the contact pads of the charging station, an electrical voltage can be applied between the measurement connections and the power connections, for example. By evaluating the resulting electrical current, electrical properties such as contact and/or insulation resistance can be determined. In this way, for example, insufficient electrical contact-connection can be detected. For example, soiling or incorrect positioning of the vehicle over the contact pads can lead to poor or faulty contact-connection. This can be checked by an initial check using the measurement connections.

The device for contact-connecting the electric vehicle and the corresponding charging station thus enables simple, convenient and safe electrical contact-connecting of the electric vehicle for charging the electric vehicle.

According to one embodiment, the device for contact-connecting an electric vehicle comprises a control unit. The control device is designed to determine a first contact resistance between the first power connection and the first measurement connection of the first group of contact elements. In particular, the first contact resistance can be determined after the first group of contact elements has made contact with the first contact pad of the charging point. The control device can also determine a second contact resistance between the second power connection and the second measurement connection of the second group of contact elements. Furthermore, the control device can determine a third contact resistance between the protective conductor connection and the second measurement connection of the second group of contact elements. The second and third contact resistance can be determined in particular after the second group of contact elements has made contact with the second contact pad of the charging point. Once the contact resistances have been determined, the control device can enable the charging process if the first, second and third contact resistances each fall below a predefined limit value. For example, the limit values for the first, second and third contact resistance can all be defined as equally large. However, individual limit values may also be specified for the three contact resistances. For example, a limit value can be specified for the contact resistance of the protective conductor connection that is lower than the contact resistances provided for the power connections. The limit values for the contact resistances can range from a few milliohms to several hundred milliohms, for example. In principle, however, limit values deviating from this are also possible depending on the application.

The contact resistances can be checked, for example, by applying an electrical voltage between the measurement connection and the corresponding power or protective conductor connection. Accordingly, the respective contact resistance can be calculated by measuring the resulting electrical current. Alternatively, a test current, in particular a voltage-limited test current, can be applied between the measurement connection and the power or protective conductor connection to be checked. In this case, the respective contact resistance can also be calculated by evaluating the resulting electrical voltage. If the device for contact-connecting the electric vehicle to the charging station is insufficiently positioned above the contact pads of the charging station or if there is dirt on one of the contact pads, for example, or if one of the contact elements is damaged or dirty, this can be detected by measuring the contact resistance accordingly. In such a case, the charging process can be stopped.

According to one embodiment, the control device is designed to check the contact resistances during a charging process. Accordingly, the control device can be designed to interrupt the charging process if at least one of the determined contact resistances exceeds the specified limit value. By continuously or periodically checking the contact resistances during the charging process, it can be ensured that a sufficiently good electrical contact-connection between the electric vehicle and the charging station is maintained throughout the charging process. If, for example, the vehicle is pushed or tilted away from the contact pads of the charging station due to an accident or similar, this can be detected immediately by increasing the monitored contact resistances. In this case, the charging process can be stopped to prevent further danger or damage.

According to one embodiment, the control device is designed to determine an insulation resistance between the first measurement connection of the first group of contact elements and the second measurement connection of the second group of contact elements. The control device can release the charging process if the determined insulation resistance exceeds a predefined limit value. Otherwise, if the insulation resistance does not exceed the specified limit value, charging can be prevented. This insulation resistance can also be checked before the start of the charging process and, if necessary, during the charging process. By checking the insulation resistance, you can ensure that there is no short circuit or leakage current between the contact pads of the charging station. For example, a value of a few megohms can be specified as the limit value for the insulation resistance.

According to one embodiment, the control device is designed to monitor the charging current during the charging process. Accordingly, the control device can be designed to interrupt the charging process if the charging current falls below a predefined minimum charging current. If the vehicle is moved, for example due to an accident or similar, this can lead to a reduction or interruption of the charging current. In such a case, the charging process can be stopped as soon as possible to prevent further danger or damage.

According to one embodiment, the device for contact-connecting the electric vehicle to the charging station comprises a protective device. The protective device is designed to enclose an area between the electric vehicle and the charging station, in particular the contact pads of the charging station, in which the first group of contact elements and the second group of contact elements are arranged. In particular, the protective device can enclose this area when the first and second groups of contact elements are in contact with the contact pads of the charging point. This protective device can, for example, be a bellows or similar. In addition, any other suitable devices that mechanically shield the components of the device for contact-connecting the electric vehicle to the charging station and the contact pads of the charging station from the environment are of course also possible. In this way, contact with live parts can be prevented during the charging process. In addition, during the charging process, dirt or other objects can be prevented from entering this area during the charging process.

According to one embodiment, the device for contact-connecting an electric vehicle to the charging station can comprise a checking device. The checking device is designed to approve the charging process only if the protective device has enclosed the area between the electric vehicle and the charging station in which the first group of contact elements and the second group of contact elements are arranged. This checking device can be one or more control switches, for example. These switches can, for example, change their switching state when the protective device has completely shielded the area to be protected. For example, the switch or switches can change their switching state after a bellows is fully extended. In this way, it is possible to check whether the area with the components carrying voltage during the charging process is reliably shielded from the environment.

According to one embodiment, the device for contact-connecting the electric vehicle to the charging station comprises a communication device. The communication device is designed to provide a communication connection between the electric vehicle and the charging station via the contact elements of the first measurement connection and the second measurement connection. Information for the charging process, for example, can be exchanged via this communication link. For example, an approval to start the charging process can be transmitted via such a communication connection. In addition, this communication link can be used to exchange information for authorization, billing or the exchange of data for the charging process, such as charging voltage, maximum charging current or similar.

The above embodiments and developments can be arbitrarily combined with one another as far as is reasonable. Further embodiments, developments, and implementations of the invention also comprise combinations not explicitly mentioned of features of the invention described above or below with respect to the exemplary embodiments. The person skilled in the art will in particular also add individual aspects as improvements or additions to the respective basic forms of the invention.

### BRIEF DESCRIPTION OF THE DRAWINGS

Further features and advantages of the invention are explained hereinafter with reference to the figures. Here:

FIG. 1: a schematic representation of a device for contact-connecting an electric vehicle according to one embodiment;

FIG. 2: a schematic representation of an underbody view of an electric vehicle with a device for contact-connecting the electric vehicle to a charging station according to one embodiment;

FIG. 3: a schematic representation of a charging station according to one embodiment; and

FIG. 4: a flow chart of a method for contact-connecting an electric vehicle to a charging station.

### DETAILED DESCRIPTION

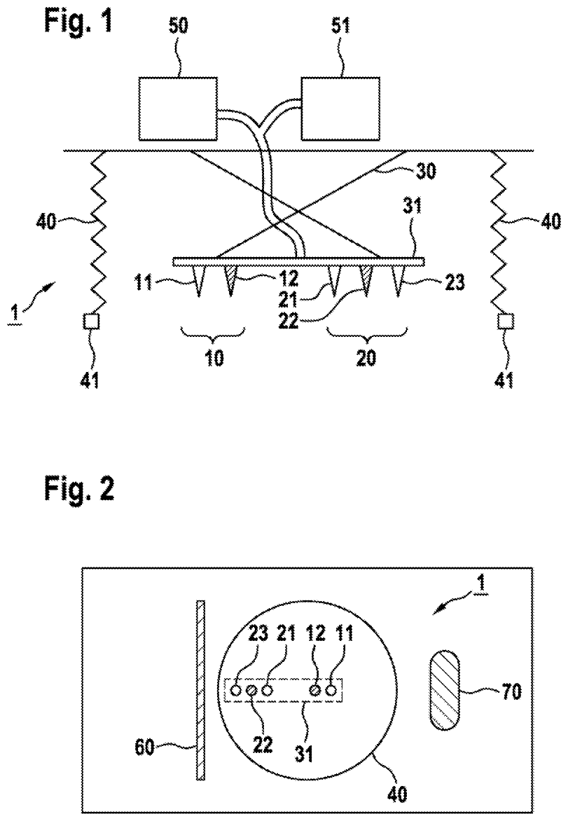

FIG. 1 shows a schematic representation of a device 1 for contact-connecting an electric vehicle to a charging station. As can be seen in this illustration, the device 1 for contact-connecting the electric vehicle to the charging station can preferably be arranged on the underside of an electric vehicle. The device 1 for contact-connecting the electric vehicle to the charging station comprises a first group 10 of contact elements with a first power connection 11 and a first measurement connection 12. Furthermore, the device 1 comprises a second group 20 of contact elements with a second power connection 21, a second measurement connection 22 and a protective conductor connection 23. The contact elements 11, 12, 21, 22, 23 can be electrically conductive contact elements that can be pressed onto corresponding contact pads of a charging station with a predetermined force. For this purpose, spring elements or similar can be provided on the individual contact elements 11, 12, 21, 22, 23, for example, which exert sufficient force on the contact pads of the charging station during contact-connection to the charging station.

If necessary, the contact elements for the first measurement connection 12 and the second measurement connection 22 can be slightly recessed in relation to the contact elements for the first power connection 11, the second power connection 22 and the protective conductor connection 23. Accordingly, during the contact-connecting process, in which the contact elements 11, 12, 21, 22, 23 are moved in the direction of the contact pads of the charging station, the contact elements of the first power connection 11, the second power connection 21 and the protective conductor connection 23 are first contacted with the contact pads and only then does the contact-connection of the first measurement connection 12 and the second measurement connection 22 take place.

The contact elements 11, 12, 21, 22, 23 can, for example, be arranged on a common carrier device 31. A positioning device 30 can move the contact elements 11, 12, 21, 22, 23 and in particular the carrier device 31 from the rest position on or in the vehicle in the direction of the contact pads of the charging station. In principle, any suitable positioning device 30 that can perform a corresponding movement is possible. For example, the positioning device 30 can be a mechanism that can be lowered or raised by means of an electric motor.

Although the embodiment of the device 1 shown in FIG. 1 for contact-connecting the electric vehicle to the charging station only shows a single contact element for the first power connection 11, the first measurement connection 12, the second power connection 21, the second measurement connection 22 and the protective conductor connection 23, it is also possible for one, several or all contact elements to be provided more than once.

In the embodiment shown in FIG. 1, the device 1 for contact-connecting the electric vehicle to the charging station comprises a protective device 40. This protective device 40 can shield an area between the underside of the electric vehicle and the ground, where the contact pads of the charging station are located and where the contact elements 11, 12, 21, 22, 23 are lowered, from the environment. For example, the protective device 40 can be a bellows or similar. This protective device 40 can, for example, be arranged on the carrier device 31 of the positioning device 30. Accordingly, when this component is lowered, the protective device 40 is also lowered and encloses an area within which the contact elements 11, 12, 21, 22, 23 are located.

Alternatively, it is also possible for the protective device 40 to be lowered or extended separately. For example, in a first step, the protective device 40 can shield the area between the vehicle and the ground with the contact pads of the charging station. In a further step, the positioning device 30 can then extend and connect the contact elements 11, 12, 21, 22, 23 to the corresponding contact pads of the charging station.

The protective device 40 can, for example, comprise one or more checking devices 41. These checking devices 41 detect whether the protective device 40 is fully or correctly extended and shields the interior with the contact elements 11, 12, 21, 22, 23. For example, the elements of the checking device 41 can be switches that change their switching state after being fully extended. In this case, the checking device 41 can only release a charging process if the protective device 40 is correctly or fully extended. Otherwise, the charging process may be prevented. In this way, the ingress of foreign bodies and intentional or accidental contact with live parts by a person or animal can be prevented.

After the positioning device 30 has lowered the contact elements 11, 12, 21, 22, 23 onto the contact pads of the charging station, predefined conditions can first be checked before a charging process is approved and the charging station applies an electrical voltage between the contact pads on the floor for this purpose. These predetermined conditions can be checked, for example, by means of a control device 50.

For example, an electrical resistance can be determined between the first power connection 11 and the first measurement connection 12. This contact resistance results on the one hand from the contact resistance between the first power connection 11 and a contact pad to which the first power connection 11 has been lowered and additionally from the contact resistance between this contact pad and the first measurement connection 12. For example, the control device 50 can apply an electrical test voltage between the first power connection 11 and the first measurement connection 12 and measure a resulting electrical current. The contact resistance is therefore the quotient of the electrical voltage and the measured current. If the electrical contact resistance between a contact element 11, 12 and the contact pad of the charging station is increased due to soiling or a foreign object, the charging process can be prevented from starting in this case. If necessary, a corresponding error message can be displayed. For example, such an error message can be shown to the driver on a display unit in the vehicle.

A contact resistance in the current path between the second power connection 21 and the second measurement connection 22 can also be determined or checked in the same way. A further contact resistance between the protective conductor connection 23 and the second measurement connection 22 can also be checked.

Furthermore, an insulation resistance between the first measurement connection 12 and the second measurement connection 22 can also be determined, for example. This insulation resistance corresponds to the insulation resistance between the two contact pads of the charging station, which provide the electrical charging voltage during the charging process. If this insulation resistance falls below a specified limit value, there is a risk of a short circuit or at least an undesirably high leakage current. To prevent this, the charging process can also be stopped if the insulation resistance falls below a specified limit value.

Once the contact resistances and/or the insulation resistance have been checked and it has been determined that the specified limit values are complied with, a charging process can be approved. For example, a corresponding signal can be transmitted from the electric vehicle, in particular from the control unit 50, to the charging station. In addition, other information, such as details about the charging process, for example specifications for the charging current, the charging voltage, a requested amount of energy or similar, can also be transmitted. Furthermore, identification and/or authentication information can also be transmitted from the vehicle to the charging station, for example.

For example, a communication device 60 can be provided to transmit information from the vehicle to the charging station. This communication device 60 can transmit information to the charging station via a wireless radio connection, for example, and/or receive information from the charging station. Alternatively, the communication device 60 can establish a communication connection to the charging station via the first measurement connection 12 and/or the second measurement connection 22.

Once the charging process has been approved, the charging station can provide an electrical voltage between the contact pads. Electrical energy can then be transmitted to the electric vehicle via the first power connection 11 and the second power connection 21 to charge the traction battery. The electric vehicle can be connected to a reference potential via the protective conductor connection 23.

During the charging process, the control device 50 can check the contact resistances between the first power connection 11 and the first measurement connection 12 as well as between the second power connection 21 and the second measurement connection 22 and also between the second measurement connection 22 and the protective conductor connection 23 continuously or at predetermined time intervals. This can be done, for example, by measuring a voltage difference between the first power connection 11 and the first measurement connection 12 or the second power connection 21 and the second measurement connection 22. Alternatively, a test current, in particular a voltage-limited test current, can be applied between the respective measurement connection 12, 22 and the power or protective conductor connections 11, 21, 23 to be checked. The respective contact resistance can also be calculated by recording the resulting electrical voltage.

It is also possible to monitor the insulation resistance between the first measurement connection and the second measurement connection during the charging process. If the monitored contact resistances exceed a predefined limit value or if the monitored insulation resistance falls below a predefined threshold value, the charging process can be stopped and the charging station can be prompted to switch off the electrical voltage at the contact pads.

In addition, a charging current can also be monitored. If the charging current falls below a specified limit value, this can also be an indication of an irregularity. Accordingly, the charging process can also be interrupted in this case.

FIG. 2 shows a schematic view of an electric vehicle with a device 1 for contact-connecting the electric vehicle to a charging station from below. To protect the device 1 for contact-connecting the electric vehicle to the charging station, the device 1 can be provided in a recess in the underbody of the vehicle, for example. If necessary, the recess with the device 1 can be closed by means of a suitable cover 60, for example a flap or a roller shutter. This cover 60 can be opened for contact-connecting. The contact elements 11, 12, 21, 22, 23 can then be lowered in order to be electrically connected to the corresponding contact pads of the charging station.

A cleaning device 70 can also be provided, for example. This cleaning device 70 can, for example, clean the contact elements and/or the contact pads of the charging station before the contact elements 11, 12, 21, 22, 23 are lowered. For example, cleaning can be carried out using compressed air or a suitable cleaning fluid. In addition, however, a mechanical cleaning device 70 or any other suitable type of cleaning device is possible, for example.

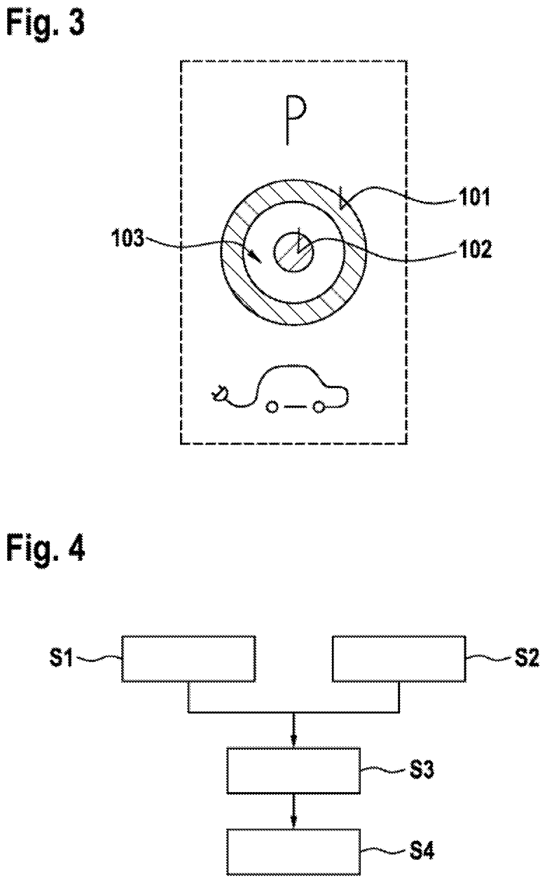

FIG. 3 shows a schematic top view of the contact pads of a charging station, as it is suitable for contact-connecting to a previously described device 1 for contact-connecting the electric vehicle to the charging station. The charging station can have a first contact pad 101 and a second contact pad 102 for this purpose. In the embodiment shown here, the second contact pad 102 is arranged concentrically around the first contact pad 101. An insulation area 103 is located between the first contact pad 101 and the second contact pad 102. Such a concentric arrangement of the contact pads 101, 102 can be provided, for example, in a central area of a parking space. Such a concentric arrangement of the contact pads in the central area of a parking space makes it possible to position the vehicle almost anywhere on the parking space. In particular, such a concentric arrangement of the contact pads enables the charging station to be used regardless of whether a vehicle is parked forwards, backwards or sideways.

After the charging process has been approved by the device 1 for contact-connecting the electric vehicle to the charging station, the charging station can then provide a charging voltage, for example an electrical alternating voltage, between the first contact pad 101 and the second contact pad 102. In principle, however, a DC voltage suitable for charging the electric vehicle is also possible between the first contact pad 101 and the second contact pad 102.

The contact pads 101 and 102 can be sufficiently large for safe and fault-tolerant contact-connecting the electric vehicle to the charging station. For example, the outer diameter of the second contact pad 102 may have a diameter of at least 50 cm, 1 m or 1.5 m.

FIG. 4 shows a flow chart of a method for contact-connecting an electric vehicle to a charging station according to one embodiment.

In step S1, contact-connection is made between a first group 10 of contact elements and a first contact pad 101 of the charging station. The first group 10 of contact elements comprises a first power connection 11 and a first measurement connection 12.

In step S2, contact-connection is made between a second group 20 of contact elements and a second contact pad 102 of the charging station. The second group 20 of contact elements comprises a second power connection 21, a protective conductor connection 23 and a second measurement connection 22.

In step S3, the contact resistances between the first power connection 11 and the first measurement connection 12, between the second power connection 21 and the second measurement connection 22 and between the protective conductor connection 23 and the second measurement connection 22 are checked.

Finally, in step S4, a charging process is enabled if the checked contact resistances fall below a predefined limit value.

In summary, the present invention relates to a device and a method for contact-connecting an electric vehicle to a charging station and a corresponding charging station. The electric vehicle can be contact-connected to the charging station by automatically lowering contact elements of the electric vehicle onto corresponding contact pads of the charging station. There is provision for additional measurement contacts in order to check reliable contact-connection of the electric vehicle to the charging station. These measurement contacts can be used to check reliable contact-connection of the connections of the electric vehicle to the contact pads of the charging station before the charging process is approved.

1. A device (1) for contact-connecting an electric vehicle to a charging station, comprising:
a first group (10) of contact elements, the first group (10) of contact elements comprising a first power connection (11) and a first measurement connection (12);
a second group (20) of contact elements, said second group (20) of contact elements comprising a second power connection (21), a protective conductor connection (23) and a second measurement connection (22); and
a positioning device (30) which is configured to contact-connect the contact elements of the first group (10) of contact elements to a first contact pad (101) of a charging point and to contact-connect the contact elements of the second group (20) of contact elements to a second contact pad (102) of a charging point.

2. The device (1) according to claim 1, comprising a control device (50) configured
to determine a first contact resistance between the first power connection (11) and the first measurement connection (12) of the first group (10) of contact elements when the first group (10) of contact elements are in contact with the first contact pad (101) of the charging point,
to determine a second contact resistance between the second power connection (21) and the second measurement connection (22) of the second group (20) of contact elements and to determine a third contact resistance between the protective conductor connection (23) and the second measurement connection (22) of the second group (20) of contact elements when the second group (20) of contact elements are in contact with the second contact pad (102) of the charging point, and
to approve a charging process if the first contact resistance, the second contact resistance and the third contact resistance each fall below a predefined limit value.

3. The device (1) according to claim 2, wherein the control device (50) is configured to check the contact resistances during a charging process and to interrupt the charging process if at least one of the determined contact resistances exceeds the respective predetermined limit value.

4. The device (1) according to claim 2, wherein the control device (50) is configured to determine an insulation resistance between the first measurement connection (12) of the first group (10) of contact elements and the second measurement connection (22) of the second group (20) of contact elements, and to approve the charging process if the determined insulation resistance exceeds a predetermined limit value.

5. The device (1) according to claim 2, wherein the control device (50) is configured to monitor a charging current during the charging process and to interrupt the charging process if the charging current falls below a predetermined minimum charging current.

6. The device (1) according to claim 1, comprising a protective device (40) adapted to enclose an area between the electric vehicle and the charging station in which the first group (10) of contact elements and the second group (20) of contact elements are arranged when the first and second group (10, 20) of contact elements are in contact with the second contact pads (101, 102) of the charging point.

7. The device (1) according to claim 6, with a checking device (41) which is configured to approve the charging process only if the protective device (40) has enclosed the area between the electric vehicle and the charging station in which the first group (10) of contact elements and the second group (20) of contact elements are arranged.

8. The device (1) according to claim 1, comprising a communication device (51) adapted to provide a communication link (51) between the electric vehicle and the charging station via the contact elements of the first measurement connection (12) and the second measurement connection (22).

9. A charging station for charging an electric vehicle, with
a first contact pad (101) adapted to be electrically connected to the first power connection (11) of a device (1) for contact-connecting an electric vehicle to the charging station, and
a second contact pad (102) adapted to be electrically connected to a second power connection (21) of the device (1) for contact-connecting an electric vehicle to the charging station,
wherein the second contact pad (102) is arranged concentrically around the first contact pad (101), and wherein an electrically insulating area (103) is arranged between the first contact pad (101) and the second contact pad (102).

10. A method for contact-connecting an electric vehicle to a charging station, comprising the steps of:
contact-connecting (S1) of a first group (10) of contact elements to a first contact pad (101) of the charging station, the first group (10) of contact elements comprising a first power connection (11) and a first measurement connection (12);
contact-connecting (S2) of a second group (20) of contact elements to a second contact pad (102) of the charging station, the second group (20) of contact elements comprising a second power connection (21), a protective conductor connection (23) and a second measurement connection (22);
checking (S3) contact resistances between the first power connection (11) and the first measurement connection (12), between the second power connection (21) and the second measurement connection (22) and between the protective conductor connection (23) and the second measurement connection (22); and
release (S4) of a charging process if the checked contact resistance falls below a predefined limit value.
